(19) United States
(12) Patent Application Publication
(10) Pub. No.: US 2015/0263791 A1
(43) Pub. Date: Sep. 17, 2015

(54) System and Method for Near Field Communication (NFC) Crowdsource Product Matrix

(71) Applicant: Jason Shih-Shen Chein, Bellevue, WA (US)

(72) Inventor: Jason Shih-Shen Chein, Bellevue, WA (US)

(21) Appl. No.: 14/656,392

(22) Filed: Mar. 12, 2015

Related U.S. Application Data
(60) Provisional application No. 61/953,547, filed on Mar. 14, 2014.

(51) Int. Cl. H04B 5/00; G06Q 10/08; H04W 4/02

(52) U.S. Cl. CPC H04B 5/0031; H04W 4/02; G06Q 10/087

(57) ABSTRACT

A method and system for managing product information is provided, the method comprising: establishing an NFC communication between an NFC chip imbedded in an NFC product and an NFC device; receiving a unique reference identification (URI) for the NFC product from the NFC chip; collecting location data of the NFC device; associating the URI with the location data; and transmitting the URI and the associated location data to a cloud infrastructure.

### CROSS-REFERENCE TO RELATED APPLICATIONS

This application claims the benefit and priority of U.S. Provisional Patent Application No. 61/953,547, entitled “Use Near Field Communication (NFC), Global Position System (GPS) and Cloud Infrastructure (Service) to Collect, Analyze, Share, and Take Action Upon Product Retail and Sell-Through Information,” filed on Mar. 14, 2014. The entire disclosures of the above application are incorporated herein by reference.

### TECHNICAL FIELD

The present invention relates to computer and communication technologies, and more particularly, to use near field communication (NFC), global positioning system (GPS) and cloud infrastructure (Service) to collect, analyze, share, and take action upon product retail and sell-through information.

### BACKGROUND

Many companies, particularly retailers and manufacturers, need to track products effectively for purposes such as inventory control and optimizing product availability. Barcode and RFID are probably the two most popular product tracking technologies that are in use today. Barcodes have the advantage of simplicity, but they can only be used to only store static information, and their functionalities are limited. RFID tags are typically attached to products to enable the companies to wirelessly detect the presence of the products, but the information contained in an RFID is generally limited to the identification number of the RFID Tag. More importantly, smartphones, which are prevalent today, are generally not equipped to read RFID tags.

Near field communication (NFC) is a set of wireless technologies that enables smartphones and other NFC devices to establish radio communication with each other by touching them together or bringing them into proximity, typically a distance of 10 cm (3.9 in) or less. NFC standards cover communications protocols and data exchange formats, and are based on existing radio-frequency identification (RFID) standards including ISO/IEC 14443 and FeliCa. The standards include ISO/IEC 18092 and those defined by the NFC Forum. NFC is becoming increasingly popular for mobile devices, and it is expected that NFC functionality will be present in the majority of smartphones in the near future.

Global Positioning System (GPS) is a satellite navigation system that provides location and time information. Alternatively, location can be determined using cellular signals. Indoor GPS, which uses Wi-Fi signals to triangulate indoor locations, is becoming popular and more accurate. There are other indoor location based technologies available on the market, such as iBeacon. Today, most of the mobile devices are equipped with some forms of location based technologies.

Crowdsourcing is a process in which services, content, or information are generated from a large group of people, each contribute a small portion, rather than traditional employees. An example would be Wikipedia, where contributors all over the world generate contents.

Therefore, there exists an opportunity for systems and methods for collecting retail product information using NFC-enabled and GPS-enabled mobile devices through the collective power of consumers.

### SUMMARY OF THE INVENTION

Embodiments of the present invention provide a method and apparatus for using near field communication (NFC), global position system (GPS) and cloud infrastructure for managing product information in retail channels.

In accordance with one embodiment of the present invention, a method for managing product information is provided, the method comprising: establishing an NFC communication between an NFC chip imbedded in an NFC product and an NFC device; receiving a unique reference identification (URI) for the NFC product from the NFC chip; collecting location data of the NFC device; associating the URI with the location data; and transmitting the URI and the associated location data to a cloud infrastructure.

In accordance with another embodiment of the present invention, the method further comprises: updating NFC data in accordance with the URI and the associated location data by the cloud infrastructure.

In accordance with yet another embodiment of the present invention, the method further comprises: establishing an NFC communication between the NFC chip imbedded in the NFC product and a second NFC device; receiving the unique reference identification (URI) for the NFC product from the NFC chip; collecting second location data of the second NFC device; associating the URI with the second location data; transmitting the URI and the associated second location data to the cloud infrastructure; and updating NFC data in accordance with the URI, the associated location data, and the associated second location data by the cloud infrastructure.

In accordance with yet another embodiment of the present invention, the method further comprises determining whether the NFC product is located at a retail outlet in accordance with the location data.

In accordance with yet another embodiment of the present invention, the method further determining whether the NFC product is located at a retail outlet in accordance with the location data; and determining whether the NFC product has been removed from the retail outlet without activation.

In accordance with yet another embodiment of the present invention, an NFC device for managing product information is provided, the NFC product comprising an NFC module configured to establish NFC communication between an NFC chip imbedded in an NFC product and the NFC device; a location module configured to obtain location data; and a client software module configured to, upon receiving a unique reference identification (URI) for the NFC product from the NFC chip through the NFC module, collect location data from the location module, associate the URI with the location data, and transmit the URI and the associated location data to a cloud infrastructure.

In accordance with yet another embodiment of the present invention, a cloud infrastructure for managing product information is provided, the cloud infrastructure comprising a database for storing NFC data and location data associated with a unique reference identification (URI) for an NFC chip imbedded in an NFC product; a server software module for analyzing location data associated with the URI; and a computational hardware for establishing network connection and hosting the server software module and the database; wherein, upon receiving location data associated with a URI from an NFC device, the server software module is configured to store the location data in a location data record associated with the URI.

In accordance with embodiments of the present invention, NFC chips are incorporated into products or product packaging (NFC Products); when a mobile device touches a NFC Product, the mobile devices reports the GPS location of the NFC Product to a cloud structure (Service). The GPS location is mapped against a database of known retail outlets to determine product distribution and availability. The collected information is analyzed and results can be used to allow manufacturers to take targeted actions to improve their operational and retail performance. The embodiments of the present invention leverages consumers' mobile devices to collect product retail information and provide manufacturers immediate knowledge on retail and sell-through performance of their products.

### BRIEF DESCRIPTION OF THE DRAWINGS

To better illustrate the technical features of the embodiments of the present invention, various embodiments of the present invention will be briefly described in conjunction with the accompanying drawings. It is obvious that the drawings are but for exemplary embodiments of the present invention, and that a person of ordinary skill in the art may derive additional drawings without deviating from the principles of the present invention.

FIG. 1 is an exemplary schematic diagram for an NFC Product in accordance with embodiments of the present invention.

FIG. 2 is an exemplary schematic diagram for a mobile device in accordance with embodiments of the present invention.

FIG. 3 is an exemplary schematic diagram for a cloud infrastructure in accordance with embodiments of the present invention.

FIG. 4 is an exemplary schematic diagram showing the setup of the NFC Products by a manufacturer in accordance with embodiments of the present invention.

FIG. 5 is an exemplary schematic diagram showing the interactions among mobile device, NFC Product, and Service at a retail outlet in accordance with embodiments of the present invention.

FIG. 6 is an exemplary schematic diagram showing the interactions among mobile device, NFC Product, and Service at a retail outlet for product registration and activation in accordance with embodiments of the present invention.

FIG. 7 is an exemplary flowchart for a method for managing product information in accordance with an embodiment of the present invention.

### DESCRIPTION OF THE PREFERRED EMBODIMENTS

To better illustrate the purpose, technical feature, and advantages of the embodiments of the present invention, various embodiments of the present invention will be further described in conjunction with the accompanying drawings.

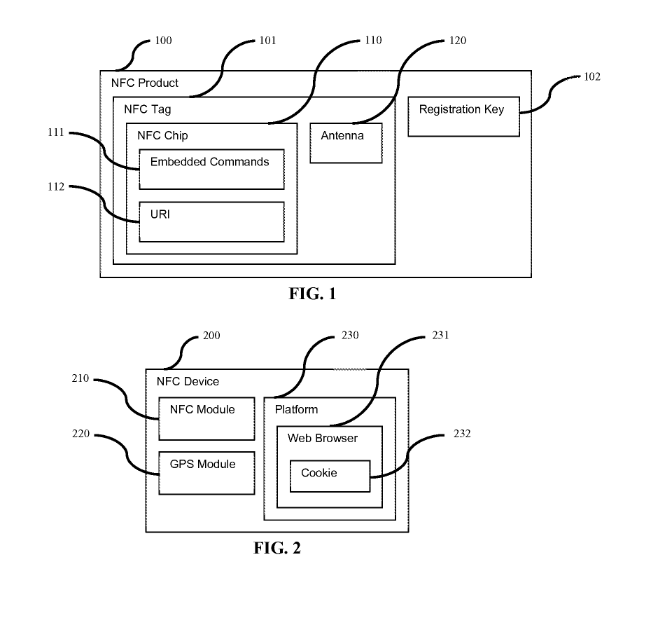

FIG. 1 is an exemplary schematic diagram for an NFC Product in accordance with embodiments of the present invention.

As shown in FIG. 1, the NFC Product 100 as a product for sale at retail channels; and has a NFC Tag 101 and a Registration Key 102. The NFC Tag 101 consists of a NFC Chip 110 (i.e. NXP NTAG203) and an Antenna 120. The NFC Chip 110 contains Embedded Commands 111 and Universal Resource Identifier (URI) 112.

Embedded Commands 111 are configured by manufacturers during the manufacturing process of NFC Products 100; specific commands are determined by targeted Platform(s) the NFC Product 100 is configured to support. URI 112 is the unique identifier of the NFC Product 100 and is referenced by Embedded Commands 111; URI 112 is generated by the NFC Products Management software module on the Service; it is also the reference to the NFC Product's corresponding NFC Data record in the Database.

Antenna 120 operates at 13.56 MHz radio frequency and is used to power NFC Chip 110 and transmit Embedded Commands 111 and URI 112 to a mobile device.

Registration Key 102 is the access code required for the customer to complete the NFC Product's registration process; it is provided by the manufacturer.

FIG. 2 is an exemplary schematic diagram for a mobile device in accordance with embodiments of the present invention.

As shown in FIG. 2, Mobile Device 200 is a mobile phone or a tablet fitted with NFC sensor (i.e. Samsung Galaxy S3 and Google Nexus 7) and GPS sensor 220. NFC Module 210 is the hardware sensor that broadcasts radio waves at 13.56 MHz frequency and retrieves Embedded Commands and URI from NFC Chips. GPS Module 220 is the hardware sensor that generates longitude and latitude information based on global positioning systems. Alternatively, GPS Module 220 can be replaced with the hardware sensor supporting other location based technologies, such as a Wi-Fi antenna or an iBeacon transmitter.

Platform 230 is the operating system (i.e. Android) on the Mobile Device 200 that serves as the gateway between the NFC Module 210, GPS Module 220, and client software. Web Browser 231 is client software that runs on the Platform using Hypertext Transfer Protocol (HTTP). Cookie 232 is a digital footprint generated by the Service; it is used to identify if the Mobile Device has interacted with the Service before.

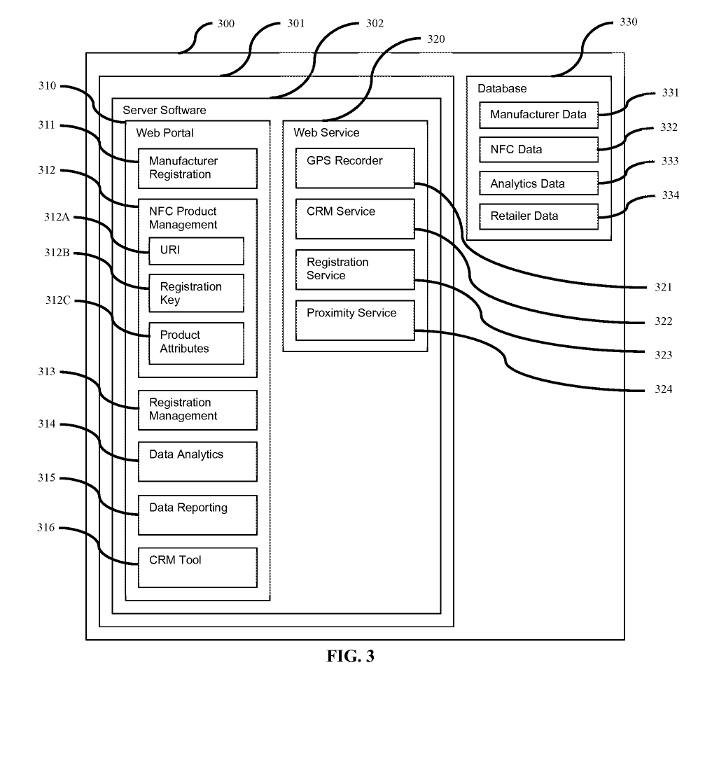

FIG. 3 is an exemplary schematic diagram for a cloud infrastructure in accordance with embodiments of the present invention.

As shown in FIG. 3, the Service 300 is a cloud infrastructure made out of Server Hardware 301, Server Software 302, and Databases 330 that manages data records, data analysis, manufacturer business logic, product registrations, customer communications, and NFC Products.

Server Hardware 301 is the computational hardware that handles communications and hosts Server Software that handles business logic.

Server Software 302 has a Web Portal access point and a Web Service access point; each access point contains software modules for specific purposes.

Web Portal 310 is used by manufacturers to register access to the Service 300, to create and manage records of their NFC Products, to manage product registration method, to analyze retail information collected, and to specify communication messages to customers.

Manufacturer Registration 311 is the software module that creates and manages information related to manufacturers.

NFC Products Management 312 is the software module that creates URI 312A for each NFC Product; this module also collects information from manufacturers and stores them within each NFC Product's corresponding NFC Data in the Database. URI 312A is the unique identifier of the NFC Product and contains information referenced by Embedded Commands of its NFC Chip; it is also the reference to NFC Product's corresponding NFC Data in the Database. Registration Key 312B is the access code required for the customer to complete the NFC Product's registration process; it is provided by the manufacturer and also serves as the link to manufacturer's own production records. Product Attributes 312C is a set of custom data related to the NFC Product (i.e. batch number, carton number, SKU number, color, etc.) and is used by the Data Analytics software module to categorize data.

Registration Management 313 is the software module for manufacturers to define their product registration method, including specific customer data required to complete the registration process. Manufacturers can configure if the customer information is stored inside NFC Data or in their own databases.

Data Analytics 314 is the software module that computes all collected retail information of NFC Products under the same manufacturer, categorizes them based on Product Attributes (i.e. batch number, carton number, SKU number, etc.) and other data attributes (i.e. product sell-through conversion by location, level of interest by product line, etc.), and stores results in the Analytics Data in the Database.

Data Reporting 315 is the software module that retrieves Analytics Data from the Database and displays them as tables, charts, and graphs to manufacturers.

Customer Relation Management (CRM) Tool 316 is the software module that allows manufacturers to specify communication messages to their customers and potential customers based on data category analyzed by the Data Analytics software module (i.e. product recall for specific batch number, price rebate for slow moving NFC Products, etc.).

Web Service 320 is used to collect GPS location, to broadcast CRM messages, to accept product registration through Web Browsers, and to broadcast GPS location of nearby NFC Products.

GPS Recorder 321 is the software module that requests and records GPS location of the NFC Product from the Web Browser; it then stores the GPS location in the NFC Product's corresponding NFC Data in the Database using URI as the reference. Given retailers often stock NFC Products in bulk, if a NFC Product is associated with a carton number, the GPS Recorder 321 further assumes all other NFC Products with the same carton number is at the same GPS location.

CRM Service 322 is the software module that broadcasts CRM messages defined by the manufacturer in the CRM Tool.

Registration Service 323 is the software module that requests and verifies Registration Key of the NFC Product from the customer; it then marks the NFC Product as sold in its NFC Data; manufacturers can collect additional information from customers per registration methods defined in the Registration Management software module; the Registration Service can store information inside NFC Data or in manufacturers' databases.

Proximity Service 324 is the software module that broadcasts GPS location of other NFC Products in nearby retailer outlets.

Database 330 is the storage that saves information related to manufacturers, NFC Products, any derived results from Data Analytics, and retail outlets.

Manufacturer Data 331 is the data record containing information on the manufacturer (i.e. name, contact details, etc.).

NFC Data 332 is the data record of each NFC Product, referenced by URI, and contains information such as manufacturer information, GPS location records, Registration Key, sell-through status, Product Attributes, product packaging, product batch, etc.

Analytics Data 333 is the data record containing the results from Data Analytics software module.

Retailer Data 334 is the data record of all known retail outlets, including their names, store number, contact details, hours of operation, location data; this record is used to determine the retail outlet of a NFC Product. Retailer Data 334 can include product availability information derived from the Analytics Data 333. For example, if a NFC Product is determined to be in a particular carton, it is mostly likely that all products in the same carton are in that retailer outlet as well. This assumes location is in place until a user interacts with the NFC Product and updates its location.

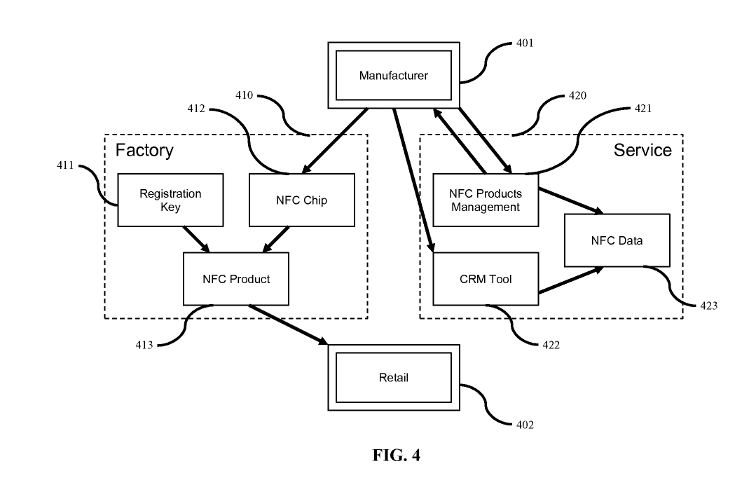

FIG. 4 is an exemplary schematic diagram showing the setup of the NFC Products by a manufacturer in accordance with embodiments of the present invention.

Setup is necessary for manufacturers to collect retail information through Mobile Devices. As shown in FIG. 4, prior to manufacturing NFC Products 413 in Factory 410, Manufacturer 401 registers with the Service 420 using Manufacturer Registration through Web Portal. Information on the manufacturer is stored in Manufacturer Data in the Database. Manufacturer 401 then uses the NFC Products Management software module 421 to create records for each NFC Product 413 it intends to produce. NFC Products Management 421 generates a unique URI for each NFC Product 413 and collects Registration Key 411 and Product Attributes information from the manufacturer 401. Manufacturer 401 then uses CRM Tool 422 to specify communication targeted at customers based on its criteria. This data is stored in each NFC Product's corresponding NFC Data 423 in the Database. Manufacturer 401 then encodes each NFC Chip 412 with URI and Embedded Commands for Platforms it intends to support. At the same time, manufacturer 401 includes the Registration Key 411 inside the NFC Product 413 or its packaging.

FIG. 4 illustrates the following setup process of NFC Products for a registered manufacturer 401:

1. Manufacturer 401 accesses the NFC Products Management software module 421 through Web Portal, creates records for new NFC Products, and submits Registration Key and Product Attributes;

2. NFC Products Management 421 generates URI for each NFC Product for manufacturer 401;

3. NFC Products Management 421 stores URI, Registration Key, and Product Attributes inside NFC Data 423;

4. Manufacturer 401 encodes URI into NFC Chips 412;

5. Manufacturer embeds NFC Chip into NFC Product 413;

6. Manufacturer 401 includes Registration Key 411 in NFC Product 413;

7. Manufacturer 401 accesses CRM Tool 422 to specify custom messages for customers who interact with the NFC Product;

8. CRM Tool 422 stores custom messages inside NFC Data 423; and

9. Manufacturer 401 ships NFC Product 423 to retail channels 402.

The Manufacturer 401 can include a wide range of product information in NFC Data 423, including product specification, product registration information, product support information, and product marketing and promotion information.

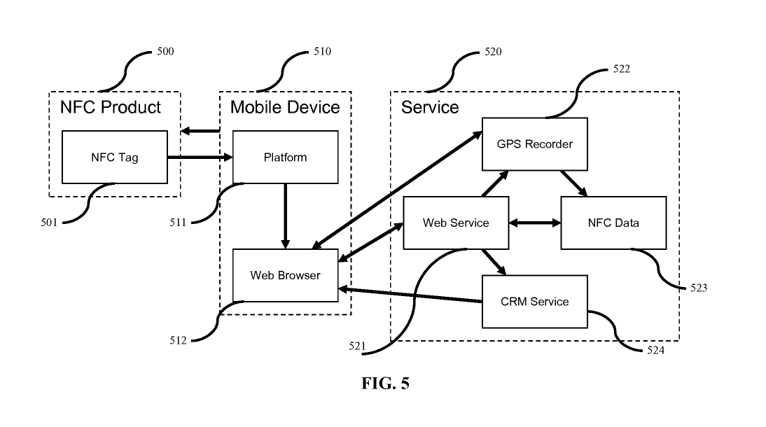

FIG. 5 is an exemplary schematic diagram showing the interactions among mobile device, NFC Product, and Service at a retail outlet in accordance with embodiments of the present invention. As shown in FIG. 5, NFC Product 500 interacts with the Service 520 through a Mobile Device 510.

After NFC Products 500 are distributed through retail channels and arrive at retail outlets, the customers connect their Mobile Devices 510 with NFC Products 500 through physical contact. When a Mobile Device 510 comes in contact with a NFC Product 500, radio wave generated by its NFC module is received by NFC Tag's Antenna to power the NFC Chip. The NFC Chip in turn transmits its Embedded Commands and URI to the NFC Module through the Antenna. Then the Platform 511 parses out Embedded Commands and executes them. An example of Embedded Commands is to launch Web Browser 512 with URI as parameter. Web Browser 512 is connected to Web Service 521 and its software modules. Upon connectivity, GPS Recorder 522 collects location of the NFC Product 500, and CRM Service 524 broadcasts manufacturer-defined communication to the customer.

There are numerous ways for manufacturers to encourage customers to interact with NFC Products 500 before their purchase, all of which can be accomplished using the CRM Tool and CRM Service 524. For example, a wine producer includes food pairing recommendation, provenance history, tasting notes, and authenticity verification as part of the manufacturer-defined communication to potential customers. This information assists users in their decisions to purchase. At the same time, through their interaction with NFC Products, product location and retail information are collected by the Service to improve manufacturer's own operation. Through Data Analytics software module, manufacturer learned that it takes an average of four customer interactions with NFC Products for every product registration. However, by improving its communication messages to potential customers, the manufacturer was able to reduce number of customer interactions down to three and therefore increased its sell-through conversion by 33%.

For products involving blind purchases, such as trading cards and collectibles, where customers do not know the exact content until purchases are made, manufacturers can still encourage customers to interact with NFC Products. For example, a user interacts with a pack of baseball cards at retail. Because that specific pack of baseball cards has not been registered, the Service knows it is still available for sale. Based on this information, the manufacturer sends a message to the user that 75% of the cards inside this pack represent American League players. If the manufacturer chooses, it can even charge users to access this information. And through the Data Analytics software module, manufacturer learned that National League players are more popular this season. Manufacturer then stimulates sell-through of packs containing American League players by offering a coupon to be redeemed at retail outlets or digital resources upon activation.

FIG. 5 illustrates the interaction between Mobile Device 510, NFC Product 500, and Service 520 for product registration at a retail outlet:

1. Mobile Device 510 comes in contact with NFC Product 500, its NFC Module powers the NFC Chip through the Antenna;

2. NFC Product 500 transmits Embedded Commands and URI to Mobile Device's Platform 511 through the Antenna and the NFC Module;

3. Platform 511 executes Embedded Commands and launches Web Browser 512 with URI data;

4. Web Browser 512 establishes connection with Web Service 521;

5. Web Service 521 retrieves NFC Product's corresponding NFC Data 523 from the Database;

6. Web Service 521 initiates GPS Recorder software module 522 with URI data;

7. GPS Recorder 522 collects GPS location from Web Browser 512;

8. GPS Recorder 522 stores GPS location in NFC Data 523 using URI;

9. Web Service 521 initiates CRM Service 524 with communication messages from NFC Data; and

10. CRM Service 524 broadcasts the message to Web Browser.

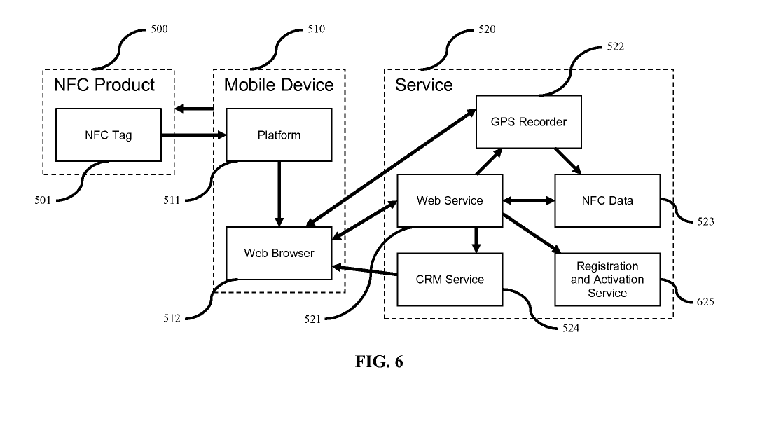

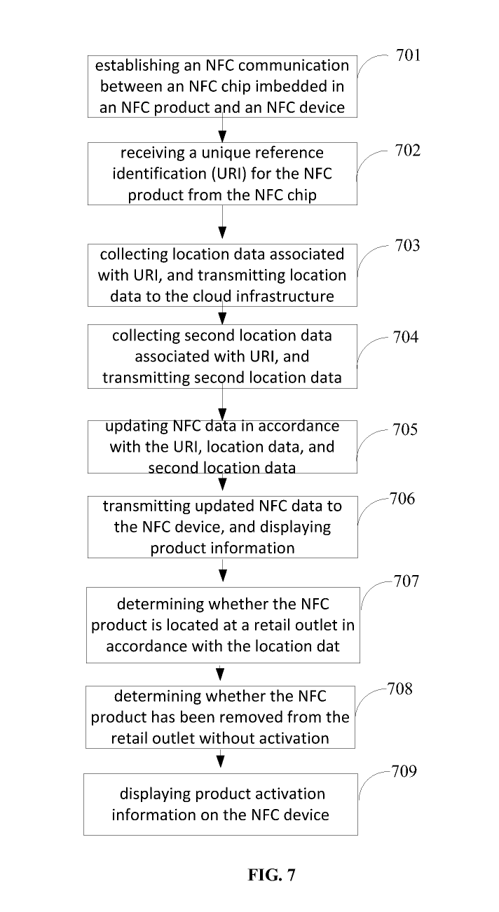

FIG. 6 is an exemplary schematic diagram showing the interactions among mobile device, NFC Product, and Service at a retail outlet in accordance with embodiments of the present invention. As shown in FIG. 6, NFC Product 500 interacts with the Service 520 through a Mobile Device 510, and the Service also includes a Registration and Activation Service 625.

After purchasing a NFC Product, the customer can register the purchase with the manufacturer. To do so, the customer connects Mobile Device to NFC Product, which executes Embedded Commands and launches Web Browser. From the Web Browser, customer navigates to the Registration Service and enters Registration Key found on the NFC Product or inside its packaging. If manufacturer defined additional information required to complete product registration through the Registration Management software module, Registration Service will request these additional information from the customer. If NFC Product is associated with certain digital resources, the manufacturer can enable access to these digital resources upon successful registration. If manufacturer defined specific communication for registered customers through the CRM Tool, CRM Service will broadcast the communication to the customer. Post registration, customer uses the Registration Service to contact manufacturer for post-sales services.

FIG. 6 illustrates the interaction between Mobile Device 510, NFC Product 500, and Service 520 for product registration:

1. Mobile Device 510 comes in contact with NFC Product 500, its NFC Module powers the NFC Chip through the Antenna;

2. NFC Product 500 transmits Embedded Commands and URI to Mobile Device's Platform 511 through the Antenna and the NFC Module;

3. Platform 511 executes Embedded Commands and launches Web Browser 512 with URI data;

4. Web Browser 512 establishes connection with Web Service 521;

5. Web Service 521 retrieves NFC Product's corresponding NFC Data 523 from the Database;

6. Web Browser 512 requests Registration and Activation Service 625;

7. Web Service 521 initiates Registration and Activation Service 625 with information from NFC Data 523;

8. Registration and Activation Service 625 requests and receives Registration Key and manufacturer defined information from Web Browser 512;

9. Registration and Activation Service 625 verifies Registration Key and marked NFC Product 500 as sold in NFC Data 523;

10. Registration and Activation Service 625 confirms registration with Web Service 512;

11. Web Service 521 refreshes NFC Product's corresponding NFC Data 523;

12. Web Service 521 initiates CRM service 524 with communication messages from NFC Data 523; and

13. CRM Service 524 broadcasts the message to Web Browser 512.

Retail information will cumulate over time. Manufacturer then uses the Data Analytics software module to compute, analyze, and categorize this data set. Results enable manufacturers to improve their forecast, marketing, operations, customer service, and more. Here are some example applications utilizing this invention.

Direct Store Traffic: Based on number of NFC Products and locations reported by users, manufacturers can determine if a retail outlet has adequate supply of their products. If a user is looking for a pair of shoes in red but can only find them in black at one retail outlet, the manufacturer can direct the user to a nearby retail outlet that has red shoes in stock.

Advance Fulfillment: Continuing the example above, the manufacturer can proactively ship red shoes to the retail outlet that has run out of stock before the retail outlet places a re-order.

Share Product Availability and Location: Based on NFC Products and their locations reported by users, or locations approximated based on association with the same carton number, manufacturers can broadcast location and inventory level of their products to potential customers.

Direct Customer Interaction: When a user interacts with a NFC Product, the manufacturer has a direct connection with the user. The manufacturer can share additional product information of the NFC Product, upsell complementary products, etc.

Targeted Promotion: By evaluating number of times a NFC Product has been interacted with Mobile Devices, number of unique users, time interval between each interaction, and comparison against similar products in the vicinity, manufacturers can determine if this NFC Product is moving through retail channels at an expected pace. If not, manufacturers can flag the NFC Product for targeted promotion next time when a potential customer interacts with it. A targeted promotion can be a rebate coupon, extended warranty, or additional digital resource that encourages the potential customer to purchase the NFC Product and completes its registration process.

Product Activation and Theft Prevention: Retail theft is a common problem, and the Service can help prevent this problem. Customers will shop as usual—take the NFC Products off the shelves and take them to the cashier. The store is installed with an activation terminal, very much like traditional anti-theft terminals that remove security devices. If a NFC Product didn't go through the activation terminal, the Service will assume it is stolen and will not authenticate its access to digital resources. Thus, the theft can have the NFC Product but not any of its digital resources. Additionally, if a NFC Product is reported stolen, the Service can potentially track it down whenever the theft attempts to use it via its GPS location data. Alternatively, the theft can be offered a chance to pay and activate the NFC Product.

FIG. 7 is an exemplary flowchart for a method for managing product information in accordance with an embodiment of the present invention. As shown in FIG. 7, the method comprises the following steps.

Step 701: establishing an NFC communication between an NFC chip imbedded in an NFC product and an NFC device.

Step 702: receiving a unique reference identification (URI) for the NFC product from the NFC chip.

Step 703: collecting location data of the NFC device, associating the location data with the URI, and transmitting the location data to a cloud infrastructure.

Step 704: collecting second location data of the second NFC device, and associating the second location data with the URI, and transmitting the second location data to the cloud infrastructure.

Step 705: updating NFC data in accordance with the URI, the associated location data, and the associated second location data by the cloud infrastructure. Here, the NFC data can be updated based on multiple location data obtained by multiple NFC devices at multiple times.

Step 706: transmitting updated NFC data to the NFC device, and displaying product information in accordance with the updated NFC data.

Step 707: determining whether the NFC product is located at a retail outlet in accordance with the location data.

Step 708: determining whether the NFC product has been removed from the retail outlet without activation. If so, there is a good chance that the NFC product has been stolen.

Step 709: if the NFC product has been removed from the retail outlet without activation, displaying product activation information on the NFC device. Here, the potential theft is being offered a chance to activate the NFC product by making appropriate payment. Alternatively, the Service can disable the digital value-add of a stolen NFC product.

As shown in FIG. 7, the NFC data can be updated on multiple location data obtained by multiple NFC devices used by multiple users at multiple times. Thus, the embodiments of the president invention can be used to harness the crowd to update the NFC data from which additional actions can be derived. For example, if a NFC product has been scanned 100 times at the same location, we would know that there are a lot of interests in this product, but for some reason there is no conversion to sales. Actions, such as formulating a specific promotion plan for this particular product, can be taken accordingly. If a NFC product has been scanned outside of the retailer outlet, then it is either purchased or that it's stolen. If no corresponding registration or activation information is available, there is a likelihood that the product is stolen, and appropriate actions can be taken.

By incorporating NFC chips inside products or packaging (NFC Products), users can send product location using NFC-enabled and GPS-enabled devices (Mobile Devices) to the Service. The GPS location is mapped against a database of known retail outlets to determine product distribution and availability. By including a registration method inside the product or packaging, users who bought the products can register their purchases to receive product warranty and other post-sale services. At the same time, registered products are marked as sold in the Service. This invention leverages Mobile Devices to collect product retail information and provide manufacturers immediate knowledge on retail and sell-through performance of their products.

The embodiments of the present invention provide manufacturers direct access to information on how their products are distributed through retail channels, level of interest from customers, and sell-through information. This data is analyzed, and the results allow manufacturers to take targeted actions to improve their operational and retail performance. When a Mobile Device touches a NFC Product, it reports GPS location of the NFC Product. The location is filtered against known retail outlets to determine where the NFC Product is being distributed. Level of interest is measured based on number of location reports of a NFC Product and time interval between each location report. Sell-through is measured when a NFC Product completes its registration or activation process. Manufacturers use this data to forecast future production volume, to balance inventory based on demand by location, to offer targeted incentives to stimulate product sell-through, to share product availability with nearby users and drive traffic to specific retail outlets, and to provide post-sale services to customers.

The embodiments of the present invention have the following advantages: Speed—NFC Products interacts with Mobile Devices by physical contact and do not require users to use separate application or input information manually; Independent—Manufacturers have direct access to retail information and reduce reliance on their retail partners for similar information; Actionable—Manufacturers can anticipate retail performance and react to changing market demands and conditions; Convenient—Customers can register their product purchases through NFC and registration method to receive post-sale services from manufacturers; Social—Manufacturers can share subset of retail information (i.e. product location) to drive specific user behavior (i.e. traffic to specific retail outlets); Direct—Manufacturers can directly communicate with their customers or potential customers when they interact with NFC Products (i.e. offer rebate coupon); Accurate—Each NFC Product is uniquely identified to track its own retail performance.

The various modules, units, and components described above can be implemented as an Application Specific Integrated Circuit (ASIC); an electronic circuit; a combinational logic circuit; a field programmable gate array (FPGA); a processor (shared, dedicated, or group) that executes code; or other suitable hardware components that provide the described functionality. The processor can be a microprocessor provided by from Intel, or a mainframe computer provided by IBM.

Note that one or more of the functions described above can be performed by software or firmware stored in memory and executed by a processor, or stored in program storage and executed by a processor. The software or firmware can also be stored and/or transported within any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any medium that can contain or store the program for use by or in connection with the instruction execution system, apparatus, or device. The computer readable medium can include, but is not limited to, an electronic, magnetic, optical, electromagnetic, infrared, or semiconductor system, apparatus or device, a portable computer diskette (magnetic), a random access memory (RAM) (magnetic), a read-only memory (ROM) (magnetic), an erasable programmable read-only memory (EPROM) (magnetic), a portable optical disc such a CD, CD-R, CD-RW, DVD, DVD-R, or DVD-RW, or flash memory such as compact flash cards, secured digital cards, USB memory devices, memory sticks, and the like.

The various embodiments of the present invention are merely preferred embodiments, and are not intended to limit the scope of the present invention, which includes any modification, equivalent, or improvement that does not depart from the spirit and principles of the present invention.

1. A method for managing product information, the method comprising:
establishing an NFC communication between an NFC chip imbedded in an NFC product and an NFC device;
receiving a unique reference identification (URI) for the NFC product from the NFC chip;
collecting location data of the NFC device;
associating the URI with the location data; and
transmitting the URI and the associated location data to a cloud infrastructure.

2. The method claim 1, further comprises:
updating NFC data in accordance with the URI and the associated location data by the cloud infrastructure.

3. The method of claim 2, further comprises:
establishing an NFC communication between the NFC chip imbedded in the NFC product and a second NFC device;
receiving the unique reference identification (URI) for the NFC product from the NFC chip;
collecting second location data of the second NFC device;
associating the URI with the second location data;
transmitting the URI and the associated second location data to the cloud infrastructure; and
updating NFC data in accordance with the URI, the associated location data, and the associated second location data by the cloud infrastructure.

4. The method of claim 1, further comprises:
upon receiving the URI from the NFC chip, receiving NFC data associated with the URI from the cloud infrastructure.

5. The method of claim 4, wherein the NFC data comprises product information of the NFC product.

6. The method of claim 5, further comprises:
determining whether the NFC product is located at a retail outlet in accordance with the location data.

7. The method of claim 6, wherein the NFC data comprises marketing information for the NFC product in accordance with the retail outlet.

8. The method of claim 6, wherein the NFC data comprises a carton number or a batch number, and the method further comprises determining the availability of NFC products associated with the carton number or the batch number at the retail outlet.

9. The method of claim 5, wherein the NFC data comprises activation information for the NFC product.

10. The method of claim 9, further comprises:
determining whether the NFC product is located at a retail outlet in accordance with the location data; and
determining whether the NFC product has been removed from the retail outlet without activation.

11. An NFC device comprising
an NFC module configured to establish NFC communication between an NFC chip imbedded in an NFC product and the NFC device;
a location module configured to obtain location data; and
a client software module configured to, upon receiving a unique reference identification (URI) for the NFC product from the NFC chip through the NFC module, collect location data from the location module, associate the URI with the location data, and transmit the URI and the associated location data to a cloud infrastructure.

12. The NFC device of claim 11, wherein the cloud infrastructure is configured to update NFC data in accordance with the URI and the associated location data.

13. The NFC device of claim 11, wherein upon receiving the URI through the NFC module, the client software module is configured to receive NFC data associated with the URI from the cloud infrastructure.

14. The NFC device of claim 13, wherein the NFC data comprises product information of the NFC product.

15. The NFC device of claim 14, wherein the NFC data indicates whether the NFC product is located at a retail outlet.

16. The NFC device of claim 15, wherein the NFC data comprises marketing information for the NFC product in accordance with the retail outlet.

17. The method of claim 15, wherein the NFC data comprises a carton number or a batch number.

18. The NFC device of claim 14, wherein the NFC data comprises activation information for the NFC product.

19. The NFC device of claim 18, wherein the NFC device is configured to determine whether the NFC product has been removed from a retail outlet without activation.

20. A cloud infrastructure for managing product information of an NFC product through an NFC device, comprising
a database for storing NFC data and location data associated with a unique reference identification (URI) for an NFC chip imbedded in the NFC product;
a server software module for analyzing location data associated with the URI; and
a computational hardware for establishing network connection and hosting the server software module and the database;
wherein, upon receiving location data associated with a URI from the NFC device, the server software module is configured to store the location data in a location data record associated with the URI.

21. The cloud infrastructure of claim 20, wherein the server software module is configured to update the NFC data in accordance with location data record associated with the URI.

22. The cloud infrastructure of claim 21, wherein the server software module is configured to receive a second location data associated with the URI from a second NFC device, and store the second location data in the location data record associated with the URI.

23. The cloud infrastructure of claim 20, wherein upon receiving the URI from the NFC device, the server software module is configured to send the NFC data associated with the URI to the NFC device.

24. The cloud infrastructure of claim 23, wherein the server software module is configured to receive updated NFC data associated with the URI from the NFC device, and to update the NFC data accordingly.

25. The cloud infrastructure of claim 23, wherein the database is configured to store location data of a retail outlet.

26. The cloud infrastructure of claim 25, wherein the server software module is configured to determine whether the NFC product is located at the retail outlet.

27. The cloud infrastructure of claim 26, wherein the NFC data comprises marketing information for the NFC product in accordance with the retail outlet.

28. The cloud infrastructure of claim 26, wherein the NFC data comprises a carton number or a batch number and the server software module is configured to determine availability of NFC products associated with the carton number or the batch number at the retail outlet.

29. The cloud infrastructure of claim 24, wherein the NFC data comprises activation information for the NFC product.

30. The cloud infrastructure of claim 29, wherein the server software module is configured to determine whether the NFC product has been removed from a retail outlet without activation.
